(19) United States
(12) Patent Application Publication
(10) Pub. No.: US 2009/0035441 A1
(43) Pub. Date: Feb. 5, 2009

(54) BEVERAGE CONTAINING FINE PULP, PROCESS FOR PRODUCING THE SAME AND EDIBLE MATERIAL

(76) Inventors: Takayuki Hirashima, Osaka (JP); Kyoko Ashikari, Osaka (JP); Masako Furukubo, Kanagawa (JP); Rakusa Sakurai, Kanagawa (JP)

Correspondence Address: HARNESS, DICKEY & PIERCE, P.L.C., P.O. BOX 8910, RESTON, VA, 20195, US

(21) Appl. No.: 10/586,388

(22) PCT Filed: Jan. 18, 2005
(86) PCT No.: PCT/JP2005/000541

§ 371 Date: Sep. 26, 2008

(30) Foreign Application Priority Data
Jan. 19, 2004 (JP) 2004-011244

(51) Int. Cl. A23L 2/06; A23L 2/02

(52) U.S. Cl. 426/599; 426/590

(57) ABSTRACT

A beverage containing fine pulp, produced at least with the use of, as a pulp component, a fine pulp wherein the content of less-than-250 μm fine pulp fraction is 5 vol. % or more while the content of 1000 μm-or-more fine pulp fraction is 60 vol. % or less. In the crushing of raw pulp by means of a homogenizer into fine pulp, it is preferable that the homogenizer pressure be 5 kg/cm² or greater. As a result, the fine pulp component and liquid component form a thorough mix, thereby enabling realization of a novel taste simultaneously realizing two mouthfeels, “viscous” and “sandy” mouthfeels.

### TECHNICAL FIELD

The present invention relates to a beverage containing fine pulp (pulp finely comminuted to a fine size), a method for producing the beverage, and an edible material suitable for the beverage and the other products. Especially, the present invention relates to a fine pulp-containing beverage in which fine pulp content and liquid content that contains fruit juice and/or the like are mixed thoroughly, so that the beverage has a novel mouthfeel that realizes “viscous” mouthfeel and “sandy” mouthfeel at the same time, a method for producing the beverage, and an edible material suitable for use in the beverage and the other products.

### BACKGROUND ART

Many fruit juice beverages containing fruit juice are known for far, which are produced from the fruit juice such as citrus fruit juice, apple juice, grape juice, and the like. Techniques for producing such fruit juice beverage mainly focus on quality improvement of the fruit juice, studying appropriateness on compositions of the beverage including the fruit juice, and the like improvement. However, as a result of recent diversity of consumer's preferences, there are marketed many fruit juice beverages containing a material other than fruit juice. Examples of such fruit juice beverages encompass: fruit flesh beverage (beverages containing fruit fleshes), fruit granule-containing fruit juice beverage (fruit juice beverages containing fruit granules); pulp-containing fruit juice beverages (fruit juice beverages in which pulp is contained); and the like.

From puree prepared by straining flesh triturated under heat application, the fruit flesh beverages are produced by blending the puree with water, sugar, souring agent, flavor, and the like, and then homogenizing the puree. The fruit flesh beverages are viscose (the order of 100 cps), sweet, rich, and palatable, that is, the fruit flesh beverage can realize the “viscous” mouthfeel. Nectar (registered trademark) and the like product exemplify the fruit flesh beverage. Examples of fruits from which the fruit flesh beverages are made encompass peach, apricot, pear, apple, mandarin, banana, guava, passion fruit, and any combination thereof. Among them, peach is most popular.

Moreover, Patent Document 1 discloses one example of technique relating to a fruit flesh beverage in which triturated citrus fruit (trituration product) is used. In this technique, the trituration product prepared by crushing the citrus fruit substantially as a whole is used, and the trituration product has, by 50 w/w % or more, a fraction having particles sizes ranging from 75 μm to 250 μm. The use of the trituration product prepared by crushing the fruit as a whole, that is, crushing the fruit with seeds makes it possible to enrich the fruit juice beverage in nutrition contents.

In addition to fruit juice, the fruit granule-containing beverages contains fruit granules, that is, Sanou (Cell sacs), and/or finely fragmented fruit flesh. The fruit granule-containing beverages gives flowing smooth mouthfeel but also a sense of eating fruit due to the fruit granules. For example, so-called “Tubutubu orange juice (granular orange juice)” is an example of such fruit granule-containing beverages.

Next, the pulp-containing fruit beverages are beverages containing pulp content in addition to the fruit juice. The pulp-containing beverages have “flowing” mouthfeel but still give sensation like tasting freshly squeezed fruit juice. For example, a technique in which pulp is added for viscosity adjustment is known.

Specifically, for example, Patent Document 2 discloses a fruit juice beverage contains fruit juice and trituration product containing fruit pulp materials, wherein some of the pulp materials are 500 μm or more in length, and the fruit juice beverage has a viscosity of 15 to 50 cps. According to Patent Document 2, the technique can provide a fruit beverage that contains relatively large fragments of fibers of the fruit but relatively smoothly flowable in mouthfeel and can be drunk with a little sensation of the existence of foreign materials. According to Patent Document 2, this fruit beverage is different from either general fruit juice beverage or fruit flesh beverage such as Nectar, and thus, this technique can provide a fruit beverage having an unconventional and novel taste.

Patent Document 3 discloses a technique in which fine citrus pulp is used instead of chemical moisture retainer, chemical dispersing agent, or chemical viscosity adjusting agent. In this technique, the fine citrus pulp finely comminuted to a size of 200 μm or less is added to various food products encompassing beverage. This gives the food products a moist mouthfeel, suppresses a change in viscosity of the food products that would occur as time pass by, and prevents separation in the food products. This technique allows adding an additive safe for human consumption in a food product.

[Patent Document 1]

Japanese Patent Application Publication, Tokukai, No. 2002-300866 (published on Oct. 15, 2002)

[Patent Document 2]

Japanese Patent Application Publication, Tokukaihei, No. 10-210956 (published on Aug. 11, 1998)

[Patent Document 3]

Japanese Patent Application Publication, Tokukai, No. 2001-128637 (published on May 15, 2001)

However, the technique for producing a fruit beverage containing a material other than fruit juice has a difficulty in attaining a wide variety of taste and in realizing an excellently balanced mouthfeel.

Specifically, in case of the fruit flesh beverage, e.g., Nectar (Registered Trademark), the fruit to be used is limited to peach and the like fruit (apple, apricot, etc.). Because of this, the fruit flesh beverage tends to have a narrow variety of taste. Further, the homogenization after the addition of other components in the strained puree can give the fruit flesh beverage “viscous” mouthfeel, but not the “sandy” mouthfeel, whereby the fruit flesh beverage has a simple mouthfeel as a drink.

Furthermore, the fruit granule-containing fruit beverage has a limitation in terms of kinds of fruits from which the fruit granules are obtained. Because of this, the fruit granule-containing fruit beverage tends to be limited to a narrow variety of taste. Furthermore, there is a difficulty in adjusting a size of the fruit granules for some kinds of fruit, while an amount of the fruit granules to be added is adjustable. For example, it is possible to adjust hardness of apple and peach fruit granules. However, hardness and size of citrus fruit granules produced from citrus Sanou are difficult to adjust. Further, the fruit granules gives “smoothly flowable” mouthfeel, but may stack in the throat or may not enter the mouth evenly. This gives such a sensation that the fruit granules and the beverage are not thoroughly mixed.

Moreover, the existence of the pulp gives “smoothly flowable” mouthfeel to the pulp-containing fruit beverage, as in the fruit granule-containing fruit beverage. The pulp is relatively easy to swallow compared with the fruit granules, but may not enter the mouth evenly sometimes. This gives such a sensation that the pulp and the beverage are not thoroughly mixed.

Here, the technique disclosed in Patent Document 1 uses the trituration product prepared by triturating citrus fruit without squeezing and straining. In such a trituration product, a fraction of a certain particle size range (75 μm to 250 μm) takes a large portion. This gives uniform mouthfeel without “sandy” mouthfeel Furthermore, the whole citrus fruit is triturated in this technique. Hence, it is expected that the trituration product contains bitter components derived from seeds and pericarp. Thus, use of the trituration product in a large amount would affect not only the mouthfeel but also taste to some extent.

Patent Document 2 describes that the technique it discloses can “provide a fruit beverage of an unconventional and novel taste” because the viscosity that reminds of fruit flesh is given to the fruit beverage by adding the fine citrus pulp therein. In Patent Document 2, however, more emphasis is laid on having a low viscosity of 15 cps to 50 cps and the fruit beverage contains pulp of a size that gets fibers sensed. Thus, the technique disclosed in Patent Document 2 cannot realize the “viscous” mouthfeel and “sandy” mouthfeel in good balance.

Furthermore, the technique disclosed in Patent Document 3 focuses on effective utilization of citrus pulp, which is a by-product of juicing citrus fruit. It is expected that this method attains “viscose” mouthfeel but not “sandy” mouthfeel because the trituration product is small in particle size. Moreover, the pulp is washed, finely comminuted, and then dried in this technique. It is expected that the fruit taste derived from pulp and the fruit mouthfeel derived from fibers, and the like would be deteriorated as a result of these steps.

The present invention is accomplished in view of the above-mentioned problems. An object of the present invention is to provide (i) such a beverage that even with pulp added therein, has a wide variety of taste, is controllable in the “viscose” mouthfeel and “sandy” mouthfeel, and attains thorough mix of fine pulp content and liquid content, (ii) a process for producing the beverage, and (iii) an edible material suitable for use in the beverage and the process.

### DISCLOSURE OF INVENTION

As a result of diligent study to attain the object, the inventors of the present invention found out a unique fact that it is possible to attain a beverage in which fine pulp content and the liquid content are thoroughly mixed together and “viscous” mouthfeel and “sandy” mouthfeel are realized at the same time, by arranging such that fine pulp is specified in terms of dimensional ranges, and preferably viscosity and/or the amount of fine pulp content and conditions (especially homogenizer pressure) in finely comminuting the raw pulp are specified. Specifically, in order to attain the object, a beverage according to the present invention containing fine pulp, the beverage comprising fine pulp content and liquid content is arranged such that the fine pulp content includes less-than-250 μm fine pulp fraction and 1000 μm-or-more fine pulp fraction; and less-than-250 μm fine pulp fraction content is 5% or more by volume, and 1000 μm-or-more fine pulp fraction content is 60% or less by volume in the fine pulp content.

In the beverage, it is preferable that the less-than-250 μm fine pulp fraction content be 70% or less by volume, and the 1000 μm-or-more fine pulp fraction content be 1% or more by volume in the fine pulp content.

Furthermore, in the beverage, it is preferable that the less-than-250 μm fine pulp fraction content be 40% or less by volume in the fine pulp content. Further, in the beverage, it is preferable that the 1000 μm-or-more fine pulp fraction content be 10% or more by volume in the fine pulp content. Moreover, in the beverage, it is preferable that the less-than-250 μm fine pulp fraction content be 15% or more by volume in the fine pulp content. Further, in the beverage, it is preferable that the 1000 μm-or-more fine pulp fraction content be 30% or less by volume in the fine pulp content.

The beverage has a viscosity preferably of 50 cps or more, and more preferably of 100 cps or more.

Further, in the beverage, a lower limit of the fine pulp content is at least 10% or more by weight, but preferably 15% or more by weight. Meanwhile, a upper limit of the fine pulp content is preferably 50% or less by weight, more preferably 45% or less by weight, further preferably 40% by weight, and especially preferably within 15 to 25% by weight.

In the beverage, it is preferable that the liquid content include fruit juice and/or vegetable juice. However, the beverage is not limited to this. Further, it is preferable that the fine pulp be pulp of citrus fruit origin. Moreover, it is preferable that the fine pulp be prepared by fragmentizing and/or triturating raw pulp.

Next, a process according to the present invention is for producing a beverage containing fine pulp, the beverage comprising fine pulp content and liquid content. The process according to the present invention includes: (a) finely comminuting raw pulp into the fine pulp, such that: the fine pulp content has less-than-250 μm fine pulp fraction and 1000 μm-or-more fine pulp fraction; and the less-than-250 μm fine pulp fraction content is 5% or more by volume, and the 1000 μm-or-more fine pulp fraction content is 60% or less by volume in the fine pulp content.

In the process, it is preferable that the step (a) comminutes the raw pulp such that the less-than-250 μm fine pulp fraction content is 70% or less by volume, and the 1000 μm-or-more fine pulp fraction content is 1% or more by volume in the fine pulp content.

It is sufficient that the process includes (b) mixing pulp content and the liquid content. There is no limitation as to when the step (b) is carried out: the process may be such (1) that in the step (b), the liquid content is mixed with the fine pulp obtained in the step (a), or (2) that in the step (b), the liquid content is mixed with the raw pulp so as to prepare a raw pulp liquid, and the step (a) is carried out after the step (b) has been is carried out.

Moreover, it is preferable that in the step (a), the raw pulp be fragmentized by using a homogenizer. In this case, the fragmentizing the raw pulp is carried out at least with homogenizer pressure of 5 kg/cm² or more. It is preferable that the homogenizer pressure be 300 kg/cm² or less. Meanwhile, it is preferable that the homogenizer pressure be 100 kg/cm² or less. Further, in the step (a), the raw pulp may be triturated by using a triturator.

Moreover, in the process according to the present invention, it is preferable that the liquid content include fruit juice and/or vegetable juice. Further, it is preferable that the fine pulp is of citrus fruit fibre origin.

Next, an edible material according to the present invention at least include: fine pulp comprising less-than-250 μm fine pulp fraction and 1000 μm-or-more fine pulp fraction, wherein less-than-250 μm fine pulp fraction content is 5% or more by volume, and 1000 μm-or-more fine pulp fraction content is 60% or less by volume in the fine pulp content.

In the edible material, it is preferable that the less-than-250 μm fine pulp fraction content is 70% or less by volume, and the 1000 μm-or-more fine pulp fraction content is 1% or more by volume.

In the edible material, it is preferable that the less-than-250 μm fine pulp fraction content be 40% or less by volume. Moreover, it is preferable that the 1000 μm-or-more fine pulp fraction content be 10% or more by volume. Further, it is preferable the less-than-250 μm fine pulp fraction content be 15% or more by volume. Furthermore, it is preferable that the 1000 μm-or-more fine pulp fraction content be 30% or less by volume. In addition, it is preferable that the fine pulp is of citrus fruit origin.

As described above, the present invention is at least arranged such that the fine pulp content is specified in terms of contents of fine pulp less than 250 μm and fine pulp not less than 1000 μm in the fine pulp content. Furthermore, the present invention is arranged such that the fine pulp content and/or the viscosity is specified. In the process according to the present invention, the homogenizer pressure is specified especially in the case where a homogenizer is used to finely comminuting the raw pulp.

With this process, it is possible to control the “viscous” mouthfeel and “sandy” mouthfeel, thereby making it possible to attain a beverage in which the fine pulp content and the liquid content are thoroughly mixed. Moreover, it is possible to attain a wide variety of taste by variously combining kinds of fruits contained in the fine pulp content and the liquid content.

As a result, it is possible to solve the conventional problems associated with the conventional beverage, namely, a narrow variety of taste, lack of the sensation that the liquid content and the solid content such as pulp and the like are thoroughly mixed, and difficulty in controlling both the viscous mouthfeel and sandy mouthfeel. Thus, it is possible to provide a beverage having a novel mouthfeel in which both the viscous mouthfeel and sandy mouthfeel are realized. Moreover, it is possible to provide novel fine pulp-containing beverages that are of high quality and sufficiently serve for widely diversified consumer preferences. Especially, the present invention is suitably applicable to fruit juice beverage.

Moreover, the edible material according to the present invention is also applicable to foods other than the beverage such as fine pulp beverage. Hence, the present invention is widely applicable not only to beverage but also various foods.

Additional objects, features, and strengths of the present invention will be made clear by the description below. Further, the advantages of the present invention will be evident from the following explanation in reference to the drawings.

### BEST MODE FOR CARRYING OUT THE INVENTION

One embodiment of the present invention is described below. Note that the present invention is not limited to the embodiment described below.

The present embodiment describes the present invention in detail by explaining contents of a fine pulp-containing beverage according to the present invention, the fine pulp-containing beverage, a process according to the present invention for producing the fine pulp-containing beverage, and applicability of the present invention, in this order.

(1) Contents of Fine Pulp-Containing Beverage

The fine pulp-containing beverage according to the present invention (hereinafter, it is referred just as “pulp beverage” where appropriate) is a composition having fine pulp content and liquid content, and may contain another or other contents (hereinafter, referred to as “other content”).

<Fine Pulp Content>

The fine pulp content contained in the pulp beverage according to the present invention is not particularly limited, provided that the fine pulp content is of plant origin and prepared by finely comminuting edible pulp. The edible pulp (i.e., raw (material) pulp) from which the fine pulp is prepared is preferably of fruit origin, and more preferably of citrus origin.

Specifically, the citrus is exemplified by orange, lemon, grapefruit, lime, mandarin, hassaku, Iyokan, navel orange, ponkan, Chinese citron, and the like, but the present invention is not limited to these fruits. The pulp of fruit origin may be used solely or two or more kinds of the pulp may be used in combination.

The present invention is not particularly limited in terms of dimension (size) of the fine pulp. Considering the fine pulp content, the fine pulp content has a fraction of fine pulp of less than 250 μm in size (this fraction is referred to as “less-than-250 μm fraction” for the sake of easy explanation), and a fraction of fine pulp of 1000 μm or more in size (this fraction is referred to as “1000 μm-or-more fraction” for the sake of easy explanation). The fine pulp content has such a particle size distribution that the less-than-250 μm fraction content is 5% or more by volume, and the 1000 μm-or-more fraction content is 60% or less by volume in the fine pulp content.

Here, the fine pulp content is preferably such that the less-than-250 μm fraction content be 70% or less by volume, and the 1000 μm-or-more fraction content is 1% or more by volume in the fine pulp content.

Moreover, it is preferably such that the less-than-250 μm fraction content be 40% or less by volume, and the 1000 μm-or-more fraction content is 10% or more by volume in the fine pulp content. Furthermore, it is preferably such that the less-than-250 μm fraction content be 15% or more by volume, and the 1000 μm-or-more fraction content is 30% or less by volume in the fine pulp content. Note that any method for measuring particle size distribution is applicable in the present invention without particular limitation.

In other words, the fine pulp content contained in the pulp beverage (or an edible material described later) is arranged such that the less-than-250 μm fraction has a lower limit of 5% or more by volume, and preferably of 15% or more by volume, and an upper limit of 70% or less by volume, and preferably of 40% or less by volume, meanwhile, the 1000 μm-or-more fraction has a lower limit of 1% or more by volume, and preferably of 10% or more by volume, and an upper limit of 60% or less by volume, and preferably of 30% or less by volume.

If the less-than-250 μm fraction content and the 1000 μm-or-more fraction content were out of the ranges mentioned above, a balance of particle sizes (size) in the fine pulp content would become non-preferable, thereby making it difficult to realize both of “viscose” mouthfeel and “sandy” mouthfeel at the same time in good balance.

There is no particular limitation as to an average dimension (size) of the fine pulp, as long as the average dimension of the fine pulp exceeds 0 μm. In the present invention, it is sufficient that, when considering the fine pulp content, the particle size distribution is within the ranges mentioned above.

The present invention is not particularly limited as to how to finely comminute the raw pulp. For example, the raw pulp may be finely comminuted by using a well-known homogenizer, a triturating device, or the like. As to specific conditions for the fine comminution will be explained in detail in “(3) Production Process”.

<Liquid Content>

The liquid content of the pulp beverage according to the present invention is not particularly limited as long as it is suitable for beverage. It is preferable that the liquid content be water or an aqueous solution. It is more preferable that the liquid content contain fruit juice and/or vegetable juice. In case where the liquid content contain fruit juice and/or vegetable juice, the liquid content may be basically fruit juice prepared by juicing fruit, or vegetable juice prepared by juicing vegetable, or a mix juice thereof.

Specific examples of the fruit and vegetable from which the fruit juice and vegetable juice are prepared encompass: citrus fruits; pome fleshly fruits/(semi-pomes) such as apple, pear (Japanese pear, western pear), and the like; drupes such as peach, apricot, plum, Japanese apricot (ume), and the like; drupels such as strawberry, raspberry, blueberry, blackberry, cassis, and the like; baccas (may be inclusive of drupels) such as grape, banana, passion fruit, and the like; tropical fruits such as pine apple, guava, mango, and the like (inclusive of banana, passion fruit and the like); fruit vegetables such as melon, water melon, and the like; vegetables such as tomato, carrot, and the like; and the like.

There is no particular limitation as to the liquid content other than the fruit juice and/or vegetable juice. Specifically, for example, the liquid content other than the fruit juice and/or vegetable juice may be water, well-known aqueous solution (sugar solution, souring agent solution, amino acid solution, electrolyte solution, or the like), alcohol or the like. Note that the present invention is not limited to these solutions. These kinds of liquid content, encompassing the fruit juice and vegetable juice, may be used solely or in combination by appropriately mixing two or more kinds thereof.

<Other Content>

The pulp beverage according to the present invention may include another or other contents other than the fine pulp content and liquid content, that is, may include “other content”. Specific examples of the other content encompass sugar, a sweetener, a souring agent, a flavor, a coloring agent, a vitamin, anti-oxidant, and the like. But, the other content is not particularly limited.

The sugar is exemplified by sugars such as sugar (cane sugar, sucrose), glucose, fructose, maltose, lactose, trehalose, other oligosaccharides, starch syrup, isomerized liquid sugar and the like; sugar alcohols such as xylitol, maltitol, erythritol, lactitol, and the like; natural sugars such as honey, maple syrup, and the like.

The sweetener is not particularly limited, provided that it can sweeten the pulp beverage according to the present invention. Specific examples of the sweetener encompass: sorbitol, aspartame, sucralose, acesulfame K, stevioside, thaumatin, glycyrrhizin, saccharin, dihydrochalcone and the like.

The sugar and sweetener may be used solely or two or more of the sugar and/or sweetener may be used in combination. Moreover, the present invention is not limited to a particular form of sugar: the sugar may be sugar in a powder form, a liquid sugar such as fructose-glucose liquid sugar, sugar having a large crystal such as granulated sugar.

The souring agent is not particularly limited, provided that the souring agent gives the pulp beverage sourness. Specific examples of the souring agent encompass: citric acid (crystal) (anhydrous), trisodium citric acid, DL-malic acid, lactic acid, phosphoric acid, tartaric acid, phytic acid, and the like. These souring agents may be used solely or two or more of them may be used in combination.

The coloring agent is not particularly limited as long as the coloring agent can color the pulp beverage according to the present invention. Specific examples of the coloring agent encompass: natural colors such as gardenia yellow, carthamus yellow, turmeric oleoresin, Benikouji yellow, palm oil carotene, monascus color, gardenia red, beet red, cochineal extract, lac color, madder color, perilla color, red cabbage color, purple sweet potato color, grape skin color, elderberry color, paprika color, annatto extract, spirulina color, cacao color, tamarind color, and the like; synthetic colors such as Food Yellow No. 4, Food Yellow No. 5, Food Red No. 2, Food Red No. 40, Food Yellow No. 102, Food Blue No. 1 (Brilliant Blue), and the like; natural coloring agents such as annatto, carotenoid, flavonoid, anthocyanin, and the like; and the like. These coloring agents may be used solely or two or more of them may be used in combination.

The flavor is not particularly limited, provided that the flavor can flavor the pulp beverage as a final product. Specific kinds of flavor encompass: citrus flavor such as orange flavor, lemon flavor, grapefruit flavor and the like; mint flavor such as peppermint flavor, spearmint flavor and the like; dairy product flavor such as yogurt flavor, butter flavor, and the like; spice flavor such as ginger flavor, cinnamon flavor, vanilla flavor, and the like; beverage flavor such as coffee flavor, wine flavor, and the like; nut flavor such as almond flavor and the like; caramel; fruit juice such as apple juice, peach juice, tropical fruit juice and the like; and the like. Moreover, it is possible to use a fruit from which pulp is derived. The flavor may be used solely or two or more of them may be used in combination.

The vitamin is not particularly limited, and may be vitamin A, vitamin B1, vitamin B2, Vitamin C, niacin, pantothenic acid, vitamin B6, biotin, vitamin B12, vitamin E, and/or the like. These vitamins may be used solely or two or more of them may be used in combination.

The antioxidant is not particularly limited, provided that the antioxidant can suppress quality deterioration of the pulp beverage due to oxidation. Specific examples of the antioxidant encompass: rutin and oxidized rutin, L-ascorbic acid and its sodium salt, erysolbic acid and its sodium salt, catechin, and the like. These antioxidants may be used solely or two or more of them may be used in combination.

Moreover, the pulp beverage according to the present invention may contain any content well known in the field of beverage production. For example, an amino acid, protein, dietary fiber, dairy content, mineral, pH adjusting agent and/or the like may be contained in the pulp beverage according to the present invention.

(2) Fine Pulp-Containing Beverage

The pulp beverage according to the present invention is a composition comprising the materials described in Section (1) within appropriate ranges. As descried in the section regarding the production method, the raw pulp, which is not fine, is finely comminuted. This allows thorough mix of the fine pulp content and the liquid content, thereby attaining novel mouthfeel in which both of the “viscose” mouthfeel and “sandy” mouthfeel are controllably realized at the same time.

<Amount of Each Content (Composition of Pulp Beverage)>

The pulp beverage according to the present invention includes at least the fine pulp content and liquid content, and if necessary further includes the other content.

Here, there is no particular limitation as to the composition of the pulp beverage according to the present invention. However, it is necessary that the essential contents, namely, the fine pulp content and liquid content should be in amounts in ranges that allows to realize the new mouthfeel in which the “viscose” mouthfeel and “sandy” mouthfeel are realized at the same time.

Specifically, the pulp beverage according to the present invention is such that, with respect to weight of the whole pulp beverage, the fine pulp content has a lower limit of 10% by weight, preferably of 15% by weight. Fine pulp content less than 10% by weight is not preferable because it cannot give the pulp beverage a sufficient viscosity, thus causing insufficient “viscous” mouthfeel. There is no particular limitation as to an upper limit of the fine pulp content. However, in order to attain a preferable flowability as a beverage while realizing the two mouthfeel at the same time, it is preferable that the fine pulp content be 50% or less by weight, preferably 45% or less by weight, and more preferably 40% or less by weight.

It is possible to specify the amount of the fine pulp content by production method. Specifically, in case where, for example, the fine pulp is prepared by comminuting the raw pulp by a homogenizer, the upper limit of the fine pulp content can be specified by homogenizer pressure. Section (3) regarding the production method will discuss this point.

<Viscosity of Pulp Beverage>

The pulp beverage according to the present invention is arranged such that the “viscous” mouthfeel and “sandy” mouthfeel can be realized in good balance. Here, the “viscose” mouthfeel can be evaluated by viscosity.

The viscosity of the pulp beverage according to the present invention is such that its lower limit is preferably 50 cps or more, and more preferably 100 cps or more. Note that there is a case where a viscosity of 50 cps or less is sufficient depending on the particle size distribution or the like of the fine pulp content. As to an upper limit of the viscosity of the pulp beverage according to the present invention, there is no particular limitation. However, a viscosity of approximately 200 cps or less can give relatively preferable concentration as a beverage.

Even though various content would influence the viscosity of the pulp beverage according to the present invention, the viscosity of the pulp beverage according to the present invention is virtually determined by extent of the fine comminution of the fine pulp content and/or how much is the fine pulp content in quantity. Accordingly, the present invention is arranged such that the viscosity can be adjusted to be within a preferably range by adjusting (a) the fine pulp content in quantity and (b) conditions (especially, the homogenizer pressure) under which the fine comminution of the pulp is performed.

(3) Production Method of Fine Pulp-Containing Beverage

The process according to the present invention for producing the fine pulp-containing beverage (hereinafter, this process is referred to just as production process sometime) includes the pulp fine comminution step for comminuting the raw pulp finely. The pulp fine comminution step produces a fine pulp content having the less-than-250 μm and the 1000 μm-or-more fraction in such a manner that the less-than-250 μm content is 5% or more by volume and the 1000 μm-or-more fraction content is 60% or less by volume in the fine pulp content.

<Pulp Fine Comminution Step>

The pulp fine comminution step is not particularly limited as long as the raw pulp described above is finely comminuted thereby. Specific examples of the pulp fine comminution step encompass a method of fragmentizing the raw pulp and a method of triturating the raw pulp. The former method utilizes a homogenizer while the latter method uses a triturator.

The homogenizer (homogenizing device, homogenizing apparatus) is not limited to a particular one, and a well-known homogenizer may be adopted suitably.

The conditions of the fine comminution of the fine pulp using the homogenizer are not particularly limited. The lower limit of total pressure of homogenizer pressure (hereinafter, this terms is abbreviated as “homo pressure”) is preferably 5 kg/cm² or more, and more preferably 50 kg/cm² or more. On the other hand, there is no particular limitation in terms of the upper limit of the total pressure of homo pressure. However, the upper limit of the total pressure of homo pressure is required to be 300 kg/cm² or less and preferably 100 kg/cm² or less in consideration of efficiency in the fine comminution and the like. It is especially preferable that the homo pressure be within a range of from 50 to 100 kg/cm² (see Examples).

The homo pressure within any of these ranges allows controlling the extent of the fine comminution of the raw pulp, that is, a dimensional range and particle size distribution of the fine pulp. If the homo pressure was within any of these ranges, a preferable “sandy” mouthfeel could be attained.

Of course, if the homo pressure was within any of these ranges, there would be a case that the dimensional range of the fine pulp is partly out of the range described in the section (1) discussing composition of the fine pulp-containing beverage. Even in this case, it is possible to sufficiently attain both the “viscous” mouthfeel and “sandy” mouthfeel at the same time by setting the homo pressure within any of these ranges.

The triturator (triturating device) is not particularly limited, and a well-known triturator may be used suitably. For example, a triturator including a grindstone may be adopted as the triturator. Conditions in the fine comminution of the raw pulp by using the triturator are not particularly limited, and well-known conditions may be adopted as appropriate.

<Relationship Between Homo Pressure and Amount of Fine Pulp Content>

As described in Section (2) discussing the fine pulp-containing beverage, the upper limit of the fine pulp content of the pulp beverage can be defined from the homo pressure in the present invention. Specifically, when the homo pressure is 5 kg/cm² or more but less than 25 kg/cm², the upper limit of the fine pulp content can be set at 40% by weight. When the homo pressure is 25 kg/cm² or more but less than 100 kg/cm², the upper limit of the fine pulp content can be set at 45% by weight. When the homo pressure is 100 kg/cm² or more but 300 kg/cm² or less, the upper limit of the fine pulp content can be set at 50% by weight.

By setting the upper limit of the fine pulp content as such, it is possible to set the fine pulp content within a preferable range in the production of the pulp beverage according to the present invention even without measuring the particle size distribution.

<Raw Pulp Liquid and Fine Pulp Liquid>

In the step of finely comminuting raw pulp, regardless of which fine comminution method is adopted, it is preferable to prepare and use a dispersion liquid (hereinafter, this liquid is referred to as a “raw pulp liquid” for easy explanation) in which the raw pulp is dispersed in water, an aqueous solution or the like. With this arrangement, it is possible to supply the raw pulp to the homogenizer or the like continuously, thereby making it possible to attain efficient fine comminution (homogenization). A product obtained by subjecting the raw pulp liquid to the fine comminution, that is, a dispersion liquid in which the fine pulp is dispersed is referred to as a “fine pulp solution” for easy explanation. The raw material liquid is not particularly limited to a specific composition.

The raw pulp liquid is not particularly limited in terms of a liquid used therein. Water, an aqueous solution, or the like may be used in the raw pulp liquid. However, it is preferable that the liquid be liquid content that can be contained in the beverage. For example, liquid content of a fruit juice and/or vegetable juice or the like as it is may be utilized as the liquid for use in the raw pulp liquid. With this arrangement, the fine pulp liquid obtained by subjecting the raw pulp liquid to the fine comminution can be utilized, as it is, for producing the pulp beverage according to the present invention.

<Mixing Step>

The production process according to the present invention includes mixing the pulp content and the liquid content. The step of mixing can be performed at any timing. Specifically, the production process according to the present invention may be arranged such that the step of mixing is performed before the step of finely comminuting the raw pulp, or that such that the step of mixing is performed after the step of finely comminuting the raw pulp.

In the arrangement in which the step of mixing is performed after the step of finely comminuting the raw pulp, the resultant fine pulp content and the liquid content are mixed together with sufficient stirring (mixing thoroughly) so that the fine pulp content will not be separated. On the other hand, in the arrangement in which the step of mixing is performed before the step of finely comminuting the raw pulp, the raw pulp and the liquid content are mixed together so as to prepare the raw pulp liquid, and then the raw pulp liquid is subjected to the fine comminution.

The step of mixing is not limited particularly in terms of conditions. In the arrangement in which the step of mixing is performed after the step of finely comminuting the raw pulp, the liquid content is mixed with the fine pulp liquid that is obtained by subjecting the raw pulp liquid to the fine comminution. In this arrangement, the other content may be added at the same time as the fine pulp liquid is added, or may be added after the fine pulp liquid and the liquid content are mixed together. On the other hand, in the arrangement in which the step of finely comminuting the raw pulp is performed after the step of mixing, the raw pulp is mixed into the liquid content so as to prepare the raw pulp liquid in which the liquid content functions as the dispersion medium.

The step of mixing is not limited to a particular mixing means, and a well-known stirring device or the like may be used in the step of mixing. Moreover, regardless of when the step of finely comminuting the raw pulp is performed, the pulp content may be mixed with liquid content not at once, that is, fractionally in twice or more. For example, a raw pulp liquid of a high concentration may be prepared with a less amount of liquid content. Then, the step of comminuting the pulp may be performed with the raw pulp liquid with the high concentration in order to prepare a fine pulp liquid. After that, the liquid content is further added in the fine pulp liquid thus prepared from the raw pulp liquid with the high concentration. Alternatively, a mixture solution of high concentration may be prepared by mixing the liquid content into a fine pulp liquid prepared by the step of finely comminuting the raw pulp, and then the liquid content may be further added in the mixture content thereby preparing the pulp beverage at the end.

<Other Steps>

It is sufficient that the production process according to the present invention includes the step of adding the pulp content (which may or may not have been finely comminuted) (i.e., the step of mixing) and the step of finely comminuting the raw pulp (i.e., the step of finely comminuting raw pulp). However it is preferable that the production process according to the present invention further include the step of pasteurizing or sterilizing, and step of filling. The steps of pasteurizing or sterilizing and the step of filling are not particularly limited and may be performed by well-known technique.

(4) Applicability of the Present Invention

As described in the later-described Examples, the pulp beverage and production method according to the present invention is applicable mainly to produce fine pulp-containing fruit juice beverage by mixing liquid content containing fruit juice or the like with fine pulp content. However, the present invention is not limited to this and the fine pulp is applicable to various food products other than the fruit juice beverage.

Specific examples of such food products encompass: frozen desserts such as ice cream, soft ice cream, moose and the like; jelly confectionary such as Yokan (sweet bean jelly), pudding, jelly, Tokoroten (gelidium jelly), Kanten (agar, Japanese gelatin), and the like; Japanese sweets such as Dango (dumpling), Mochi (rice cake), and the like; processed fruit products such as fruit pastes, jams, marmalades, and the like; sources and syrups such as dressing, various syrups, fruit sources, and the like; soups such as pureed soups, cream soups, consommé soups and the like; and the like. However, the present invention is not limited to these.

As described above, the fine pulp according to the present invention is widely applicable as an edible material to various products besides beverages.

Process according to the present invention for producing the edible material is not particularly limited, provided that the process includes the step of finely comminuting the raw pulp described in Section (3) regarding the process for producing the fine pulp-containing beverage.

In the following, the present invention is specifically described referring to Examples, which describe fruit juice beverages as typical examples. It should be noted that the present invention is not limited to these Examples. In Examples, what is meant by the term “% by weight” is “weight/volume % (w/v %).

### EXAMPLE 1

Raw pulp liquid was prepared, which contained orange pulp by 50% by weight and water by 50% by weight. The raw pulp liquid was processed with a homogenizer manufactured by APV GAULIN Corp., so as to obtain a fine pulp liquid (step of finely comminuting raw pulp). Here, the process with the homogenizer was carried out with a homo pressure of 50 kg/cm².

Next, the fine pulp liquid of 40.0% by weight (which gave fine pulp of 20% by weight), orange juice of 10.0% by weight, fructose-glucose liquid sugar of 10.0% by weight, citric acid of 0.1% by weight, flavor of 0.2% by weight, and water in an appropriate amount were added together, (the step of mixing) thereby producing a solution of a total amount of 1000 ml. After that, the solution thus obtained was pasteurized and filled.

The thus obtained pulp solution was tasted. The tasting found that the fine pulp content and the liquid content containing the fruit juice and the like were thoroughly mixed and “viscous” mouthfeel and “sandy” mouthfeel were both realized at the same time in the pulp solution.

### EXAMPLE 2

Firstly, orange pulp (raw pulp) of 20.0% by weight, orange juice of 10.0% by weight, fructose-glucose liquid sugar of 10.0% by weight, citric acid of 0.1% by weight, flavor of 0.2% by weight, and water in an appropriate amount were added together, (the step of mixing) thereby producing a solution of a total amount of 1000 ml. After that, the solution thus obtained was processed with the homogenizer under the same condition as in Example 1, so as to finely comminute the orange pulp (the step of finely comminuting the raw pulp). Except that, the solution was pasteurized and filled in a container in the same fashion as in Example 1.

The thus obtained pulp solution was tasted. The tasting found that the fine pulp content and the liquid content containing the fruit juice and the like were thoroughly mixed and “viscous” mouthfeel and “sandy” mouthfeel were both realized at the same time in the pulp solution, like the pulp solution of Example 1.

### EXAMPLE 3

Pulp beverages were produced in the same manner as in Example 2, except that orange pulp of 20% by weight was mixed in and the pulp beverages were produced with various homo pressures, 0, 5, 25, 50, 75, 100, 200, and 300 kg/cm². Table 1 shows particle size distributions of fine pulps in the pulp beverages thus produced with various homo pressures. That is, Table 1 shows the particle size distributions of the fine pulp against the various homo pressures. The particle size distribution was measured by using a particle size distribution analyzer made by Deckman Coulter Inc.

TABLE 1

| HP | Fine Pulp Particle Distribution (% by volume) | | | | | | |
|---|---|---|---|---|---|---|---|
| (Kg/ | <75 | 75 to | 250 to | 500 to | 750 to | ≧1000 | |
| cm²) | μm | 250 μm | 500 μm | 750 μm | 1000 μm | μm | Total |
| 0 | 1.1 | 3.0 | 7.3 | 8.9 | 13.3 | 66.4 | 100.0 |
| 5 | 1.6 | 4.9 | 10.9 | 11.9 | 15.5 | 55.2 | 100.0 |
| 25 | 2.1 | 8.9 | 18.1 | 15.6 | 15.8 | 39.5 | 100.0 |
| 50 | 3.3 | 13.9 | 22.6 | 16.2 | 14.8 | 29.2 | 100.0 |
| 75 | 6.6 | 27.0 | 30.4 | 14.1 | 9.7 | 12.2 | 100.0 |
| 100 | 6.8 | 28.8 | 30.9 | 13.4 | 8.0 | 12.1 | 100.0 |
| 200 | 13.1 | 42.3 | 28.7 | 8.8 | 4.2 | 2.9 | 100.0 |
| 300 | 19.3 | 49.0 | 23.6 | 4.9 | 2.1 | 1.1 | 100.0 |

Note:
the range “xxx to yyy μm” indicates a range more than xxx μm but less than yyy μm.
Abbreviation: “HP” stands for Homogenizer Pressure.

### EXAMPLE 4

Pulp beverages were produced in the same manner as in Example 3, except that each pulp beverage was produced with a homo pressure of 50 kg/cm² but respectively with various orange pulp contents, 10, 20, and 40% by weight. Table 2 shows particle size distributions of fine pulps in the pulp beverages thus produced with various orange pulp contents. That is, table 2 shows the particle size distributions of the fine pulp against the various homo pressures.

TABLE 2

| | | Fine Pulp Particle Distribution (% by volume) | | | | | | |
|---|---|---|---|---|---|---|---|---|
| HP | PC | | 75 to | 250 to | 500 to | 750 to | ≧1000 | |
| (Kg/cm²) | (wt %) | <75 μm | 250 μm | 500 μm | 750 μm | 1000 μm | μm | Total |
| 50 | 10 | 3.8 | 15.0 | 23.7 | 16.2 | 14.0 | 27.3 | 100.0 |
| 50 | 20 | 3.3 | 13.7 | 23.3 | 16.5 | 14.7 | 28.5 | 100.0 |
| 50 | 40 | 3.2 | 11.8 | 21.9 | 16.3 | 14.6 | 32.2 | 100.0 |

Note:
the range “xxx to yyy μm” indicates a range more than xxx μm but less than yyy μm.
Abbreviation: “HP” stands for Homogenizer Pressure.
“CP” stands for Pulp Content.

### EXAMPLE 5

Pulp beverages were produced in the same manner as in Example 3, except that each pulp beverage was produced with a homo pressure of 5 kg/cm² but respectively with various orange pulp contents, 50, 70, and 100% by weight. Table 3 shows particle size distributions of fine pulps in the pulp beverages thus produced with various orange pulp contents. That is, Table 3 shows the particle size distributions of the fine pulp against the various homo pressures.

TABLE 3

| | | Fine Pulp Particle Distribution (% by volume) | | | | | | |
|---|---|---|---|---|---|---|---|---|
| HP | PC | | 75 to | 250 to | 500 to | 750 to | ≧1000 | |
| (Kg/cm²) | (wt %) | <75 μm | 250 μm | 500 μm | 750 μm | 1000 μm | μm | Total |
| 5 | 50 | 1.1 | 2.8 | 6.8 | 9.0 | 13.8 | 66.5 | 100.0 |
| 5 | 70 | 0.8 | 2.3 | 6.6 | 8.8 | 13.4 | 68.1 | 100.0 |
| 5 | 100 | 0.8 | 2.3 | 6.8 | 9.4 | 13.9 | 66.8 | 100.0 |

Note:
the range “xxx to yyy μm” indicates a range more than xxx μm but less than yyy μm.
Abbreviation: “HP” stands for Homogenizer Pressure.
“CP” stands for Pulp Content.

### EXAMPLE 6

Pulp beverages were produced in the same manner as in Example 3, except that each pulp beverage was produced respectively with various orange pulp contents and homo pressures as indicated in Table 4. The pulp beverages thus produced were evaluated in 5 grades on the “viscous” mouthfeel and “sandy” mouthfeel, and on how these mouthfeels were sensed in oneness. The 5 grades are: 5.0 is “very strong”; 4.0 is “strong”; 3.0 is “slightly strong”, 2.0 is “slightly week”, 1.0 is “weak”, 0.0 is “not sensed”. The results are shown in Table 4.

TABLE 4

| | | Sensory Analysis | | |
|---|---|---|---|---|
| HP (Kg/cm²) | PC (wt %) | “Viscose” | “Sandy” | Oneness |
| 0 | 0 to 10 | 0.2 | 4.0 | 0 |
| | 10 to 15 | 0.2 | 4.5 | 0 |
| | 15 to 20 | 0.2 | 5.0 | 0 |
| | 20 to 40 | 0.2 | 5.5 | 0 |
| 5 | 0 to 10 | 0.5 | 3.8 | 0.3 |
| | 10 to 15 | 1.5 | 4.3 | 1.2 |
| | 15 to 20 | 2.5 | 4.8 | 2.0 |
| | 20 to 40 | 3.0 | 5.0 | 2.5 |
| 25 | 0 to 10 | 0.8 | 3.5 | 0.5 |
| | 10 to 15 | 2.0 | 4.0 | 2.0 |
| | 15 to 20 | 3.0 | 4.5 | 2.5 |
| | 20 to 45 | 3.3 | 4.8 | 3.0 |
| 50 | 0 to 10 | 1.5 | 2.8 | 0.7 |
| | 10 to 15 | 3.0 | 3.5 | 3.0 |
| | 15 to 20 | 4.0 | 4.0 | 4.0 |
| | 20 to 45 | 4.3 | 4.3 | 4.5 |
| 75 | 0 to 10 | 1.5 | 2.8 | 0.7 |
| | 10 to 15 | 3.0 | 3.5 | 3.0 |
| | 15 to 20 | 4.0 | 4.0 | 4.0 |
| | 20 to 45 | 4.3 | 4.3 | 4.5 |
| 100 | 0 to 10 | 1.8 | 2.5 | 0.8 |
| | 10 to 15 | 3.2 | 3.2 | 3.5 |
| | 15 to 20 | 4.2 | 3.5 | 4.2 |
| | 20 to 50 | 4.6 | 3.7 | 4.7 |
| 200 | 0 to 10 | 1.8 | 2.0 | 0.8 |
| | 10 to 15 | 3.2 | 2.2 | 4.2 |
| | 15 to 20 | 4.2 | 2.5 | 4.7 |
| | 20 to 50 | 4.6 | 2.5 | 5.0 |
| 300 | 0 to 10 | 1.8 | 1.6 | 0.8 |
| | 10 to 15 | 3.2 | 2.0 | 4.2 |
| | 15 to 20 | 4.2 | 2.2 | 4.7 |
| | 20 to 50 | 4.6 | 2.2 | 5.0 |

Abbreviation: “HP” stands for Homogenizer Pressure.
“CP” stands for Pulp Content.
“Viscose” stands for viscose mouthfeel.
“Sandy” stands for sandy mouthfeel.

The results show that the fine pulp content used in the present invention should be such that less-than-250 μm fraction content is 5% or more by volume but 70% or less by volume, and 1000 μm-or-more fraction content is 1% or more by volume but 60% or less by volume in the fine pulp content. Moreover, the results show that a total pressure of the homo pressure is preferably 5 kg/cm² or more. The results regarding the balance and sensation of oneness between the mouthfeels in Example 6 show that it is more preferable that the homo pressure be within 50 to 100 kg/cm².

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

As described above, the fine pulp is specified in terms of dimensional ranges, and preferably the conditions (especially the homo pressure) in finely comminuting the raw pulp and/or the viscosity is specified in the present invention. This makes it possible to realize “viscous” mouthfeel and “sandy” mouthfeel at the same time in a beverage produced according to the present invention.

Hence, the present invention is applicable not only to the industry producing beverages among the food industries, but also to other food industries, for example, the industries producing alcohol beverages, sweets, and the like. Furthermore, the present invention is applicable to the agricultural product processing industries that process fruits. Moreover, because the fine pulp can be used as edible material, it is possible to apply the present invention to the food industries producing foods other than beverages.

1. A beverage containing fine pulp, the beverage comprising fine pulp content and liquid content, wherein:
the fine pulp content includes less-than-250 μm fine pulp fraction and 1000 μm-or-more fine pulp fraction; and
less-than-250 μm fine pulp fraction content is 5% or more by volume, and 1000 μm-or-more fine pulp fraction content is 60% or less by volume in the fine pulp content.

2. The beverage as set forth in claim 1, wherein:
the less-than-250 μm fine pulp fraction content is 70% or less by volume, and the 1000 μm-or-more fine pulp fraction content is 1% or more by volume in the fine pulp content.

3. The beverage as set forth in claim 1, wherein:
the less-than-250 μm fine pulp fraction content is 40% or less by volume in the fine pulp content.

4. The beverage as set forth in claim 1, wherein:
the 1000 μm-or-more fine pulp fraction content is 10% or more by volume in the fine pulp content.

5. The beverage as set forth in claim 1, wherein:
the less-than-250 μm fine pulp fraction content is 15% or more by volume in the fine pulp content.

6. The beverage as set forth in claim 1, wherein:
the 1000 μm-or-more fine pulp fraction content is 30% or less by volume in the fine pulp content.

7. The beverage as set forth in claim 1, having a viscosity of 50 cps or more.

8. The beverage as set forth in claim 1, having a viscosity of 100 cps or more.

9. The beverage as set forth in claim 1 comprising the fine pulp content by 10% or more by weight.

10. The beverage as set forth in claim 1 comprising the fine pulp content by 15% or more by weight.

11. The beverage as set forth in claim 1 comprising the fine pulp content by 50% or less by weight.

12. The beverage as set forth in claim 1 comprising the fine pulp content by 45% or less by weight.

13. The beverage as set forth in claim 1 comprising the fine pulp content by 40% or less by weight.

14. The beverage as set forth in claim 1, wherein:
the liquid content comprises fruit juice and/or vegetable juice.

15. The beverage as set forth in claim 1, wherein:
the fine pulp is of citrus fruit origin.

16. The beverage as set forth in claim 1, wherein:
the fine pulp is prepared by fragmentizing and/or triturating raw pulp.

17. A process for producing a beverage containing fine pulp, the beverage comprising fine pulp content and liquid content, the process comprising:
(a) finely comminuting raw pulp into the fine pulp, such that:
the fine pulp content has less-than-250 μm fine pulp fraction and 1000 μm-or-more fine pulp fraction; and
less-than-250 μm fine pulp fraction content is 5% or more by volume, and 1000 μm-or-more fine pulp fraction content is 60% or less by volume in the fine pulp content.

18. The process as set forth in claim 17, wherein:
the step (a) comminutes the raw pulp such that the less-than-250 μm fine pulp fraction content is 70% or less by volume, and the 1000 μm-or-more fine pulp fraction content is 1% or more by volume in the fine pulp content.

19. The process as set forth in claim 17, comprising:
(b) mixing pulp content and the liquid content.

20. The process as set forth in claim 17, wherein:
in the step, the liquid content is mixed with the fine pulp obtained in the step.

21. The process as set forth in claim 17, wherein:
the liquid content is mixed with the raw pulp so as to prepare a raw pulp liquid.

22. The process as set forth in claim 17, wherein:
the raw pulp is fragmentized by using a homogenizer.

23. The process as set forth in claim 22, wherein:
the fragmentizing the raw pulp is carried out with homogenizer pressure of 5 kg/cm² or more.

24. The process as set forth in claim 23, wherein:
the homogenizer pressure is 300 kg/cm² or less.

25. The process as set forth in claim 23, wherein:
the homogenizer pressure is 50 kg/cm² or more.

26. The process as set forth in claim 23, wherein:
the homogenizer pressure is 100 kg/cm² or less.

27. The process as set forth in claim 17, wherein:
the raw pulp is triturated by using a triturator.

28. The process as set forth in claim 17, wherein:
the liquid content comprises fruit juice and/or vegetable juice.

29. The process as set forth in claim 17, wherein:
the fine pulp is of citrus fruit fibre origin.

30. An edible material, at least comprising:
fine pulp comprising less-than-250 μm fine pulp fraction and 1000 μm-or-more fine pulp fraction,
wherein the less-than-250 μm fine pulp fraction content is 5% or more by volume, and 1000 μm-or-more fine pulp fraction content is 60% or less by volume in the fine pulp content.

31. The edible material as set forth in claim 30, wherein:
the less-than-250 μm fine pulp fraction content is 70% or less by volume, and the 1000 μm-or-more fine pulp fraction content is 1% or more by volume.

32. The edible material as set forth in claim 30, wherein:
the less-than-250 μm fine pulp fraction content is 40% or less by volume.

33. The edible material as set forth in claim 30 32, wherein:
the 1000 μm-or-more fine pulp fraction content is 10% or more by volume.

34. The edible material as set forth in claim 30, wherein:
the less-than-250 μm fine pulp fraction content is 15% or more by volume.

35. The edible material as set forth in claim 30, wherein:
the 1000 μm-or-more fine pulp fraction content is 30% or less by volume.

36. The edible material as set forth in claim 30, wherein:
the fine pulp is of citrus fruit origin.
